(19) United States
(12) Patent Application Publication
(10) Pub. No.: US 2018/0284431 A1
(43) Pub. Date: Oct. 4, 2018

(54) ADJUSTABLE HEAD-UP DISPLAY SYSTEM OF ALL TIME

(71) Applicant: E-LEAD ELECTRONIC CO., LTD., CHANGHUA (TW)

(72) Inventor: Stephen CHEN, CHANGHUA (TW)

(21) Appl. No.: 15/475,064

(22) Filed: Mar. 30, 2017

(51) Int. Cl. G02B 27/01; G02B 5/30

(52) U.S. Cl. CPC G02B 27/0101; G02B 2027/0118; G02B 5/30

(57) ABSTRACT

The present invention relates to an adjustable head-up display system of all time, which includes a display device, a rotating device, a windshield and a second half-wave plate, wherein the rotating device including a first half-wave plate and a power module is provided to control the power module for rotating the first half-wave plate, to let s-polarized light and p-polarized light interchange with each other, to solve the problem that images displayed by head-up displays couldn't be read if drivers wear polarized sunglasses and the image distorted problem in rainy days, to thereby provide drivers with displayed images with optimized visual effects for all time.

### BACKGROUND OF THE INVENTION

### a) Field of the Invention

The present invention relates to an adjustable head-up display system of all time and, more particularly, to an adjustable head-up display system of all time provided for all weather without visual impairment, to solve the drawback that images displayed by head-up displays couldn't be read if drivers wear polarized sunglasses and overcome the image distorted problem in rainy days, to thereby provide drivers with displayed images with optimized visual effects for all time, to improve driving safety effectively.

### b) Description of Prior Art

Head-up displays of vehicle would be usually set below the dashboard under the windshield, and light would be projected upwards to the windshield is and rejected to driver's eyes by the windshield. The angle of windshields of common vehicles, especially passenger cars, is 25-35 degrees above the horizontal, for safety considerations, angle of view of head-up displays would be usually designed at about 5 degrees below drivers' horizontal line of sight, so that it would not only be easily read by drivers, but not block important line of sight, by calculating from such an angle, the incident angle of light of head-up displays to the windshield is about 60-70 degrees.

As shown in FIG. 1, it is a curve diagram of s-polarized light, p-polarized light and reflectivity according to Fresnel Equations. It would be known from the figure that the reflectivity of s-polarized light is far greater than the reflectivity of p-polarized light in the range of the incident angle, the reflectivity of p-polarized light is even close to zero if the incident angle is close to 60 degrees. Thus, screen of head-up displays should be strong for drivers to read when vehicles are in the strong sunshine. In order to increase projection efficiency of head-up displays, s-polarized light may be chosen as a light source of an imaging screen of a common head-up display, or light output from the imaging screen may be converted to s-polarized light by using a suitable wave plate and then projected to the windshield for obtaining greater amount of reflected light.

As shown in FIG. 2, a half-wave plate 6 with s-polarized light (s shown in figure) could solve multiple image problem, due to Brewster's angle, the reflectivity of p-polarize light (p shown in figure) is nearly zero on the windshield G, but images couldn't be seen with polarized sunglasses if s-polarized light (s shown in figure) is used.

As shown in FIG. 3, a half-wave plate 6 is used with p-polarized light, so that low-reflection problem of Brewster's angle and invisible problem of polarized sunglasses could be solved.

Please refer to FIG. 4, a half-wave plate 6 is used with p-polarized light, when it rains, raindrops attach to the windshield G, since the reflection layer is the outermost layer of the windshield G, so it may be affected by raindrops, images of head-up displays may have irregular distortion after being reflected is on the surface with raindrops, it causes images being distorted, this problem may also let the utility of head-up displays be greatly reduced.

In order to solve the above problems, the industry propose solutions continuously, related technology could be referred to cited references U.S. Pat. No. 5,510,913, U.S. Pat. No. 6,042,947, CN 20150635147.2, CN 201610609828.6, CN 201610715723.9, JP published patent application 2-141720, TW publication number 201621399, 20160862856, TW patent certificate number 1422860, 1296720, 1464493,1545375.

Most of the above cited references have already improved the functions of head-up display devices, but there are still some bottlenecks to overcome, for example, in some cited references, the problem that images displayed on a windshield by a head-up display could not be read with wearing polarized sunglasses has already been solved, but not for image distortion problem caused by raindrops attach to the windshield G in rainy days; thus, so far there is still no good solution for solving the above problems at the same time, so that use of head-up displays could not achieve full-time requirements, and it is also the problem that drivers often criticize.

### SUMMARY OF THE INVENTION

In view of the drawbacks of the conventional ones, the inventor finally completed the adjustable head-up display system of all time of the present invention after numerous improvements, namely, the object of the present invention is to provide an adjustable head-up display system of all time provided for all weather without visual impairment, to solve the drawback that polarized sunglasses couldn't be used to read images displayed by head-up displays and overcome the image distorted problem in rainy days, to thereby provide drivers with displayed images with optimized visual effects for all time, to improve driving safety effectively.

To achieve the object of the present invention, the adjustable head-up display system of all time of the present invention includes:

a display device;

a rotating device, which includes a first half-wave plate and a power module, the first half-wave plate is set in front of the display device, the first half-wave plate is connected to the power module;

a windshield, which includes a first glass and a second glass, light projected by the display device reflects on the windshield;

a second half-wave plate, which is set between the first glass and the second glass.

The above first half-wave plate and the second half-eave plate are transparent plastic material.

The above rotating device further includes a switch, the switch is provided to control the power module for rotating the first half-wave plate.

The above rotating device further includes a signal switch, the signal switch is provided to control the power module for rotating the first half-wave plate.

The above display device includes a projection device and an imaging screen, the imaging screen is a 45 degree linear polarization imaging screen.

The above display device includes a projection device and an imaging screen, the imaging screen is an imaging screen using p-polarized light.

The above display device includes a projection device and an imaging screen, the imaging screen is an imaging screen using s-polarized light.

The above power module is an electric motor.

The above first half-wave plate is a sector plate body.

The above display device includes a projection device and an imaging screen.

The adjustable head-up display system of all time of the present o invention, the feature is to provide a head-up display system of all time provided for all weather without visual impairment, to solve the drawback that polarized sunglasses couldn't be used to read images displayed by head-up displays and overcome the image distorted problem in rainy days; drivers could manually or automatically control the output as s-polarized light or p-polarized light is according to weather conditions, to provide drivers with displayed images with optimized visual effects for all time, to improve driving safety.

### BRIEF DESCRIPTION OF THE DRAWINGS

FIG. 1 is a curve diagram of different incident angles and reflectivity in prior art;

FIG. 2 is a schematic diagram of light path of s-polarized light passing through the half-wave plate in prior art;

FIG. 3 is a schematic diagram of light path of p-polarized light passing through the half-wave plate in prior art;

FIG. 4 is a schematic diagram of light path of a windshield with raindrops attached on its surface in prior art;

FIG. 5 is a schematic diagram of light path of the present invention;

FIG. 6 is a schematic diagram of the first embodiment of the present invention;

FIG. 7 is a schematic diagram of the second embodiment of the present invention;

FIG. 8 is another schematic diagram of the second embodiment of the present invention;

FIG. 9 is a schematic diagram of rotation of the first half-wave plate controlled manually of the present invention; and

FIG. 10 is a schematic diagram of rotation of the first half-wave plate controlled automatically of the present invention.

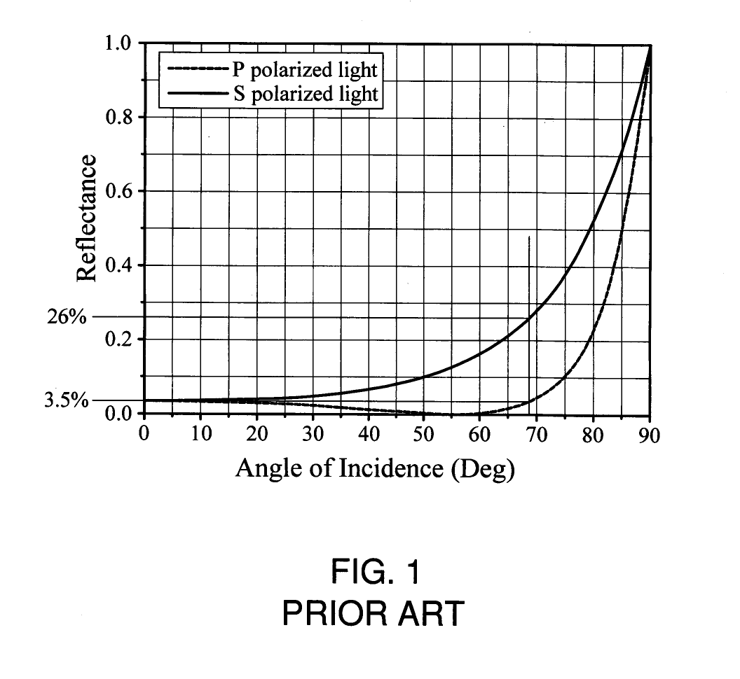

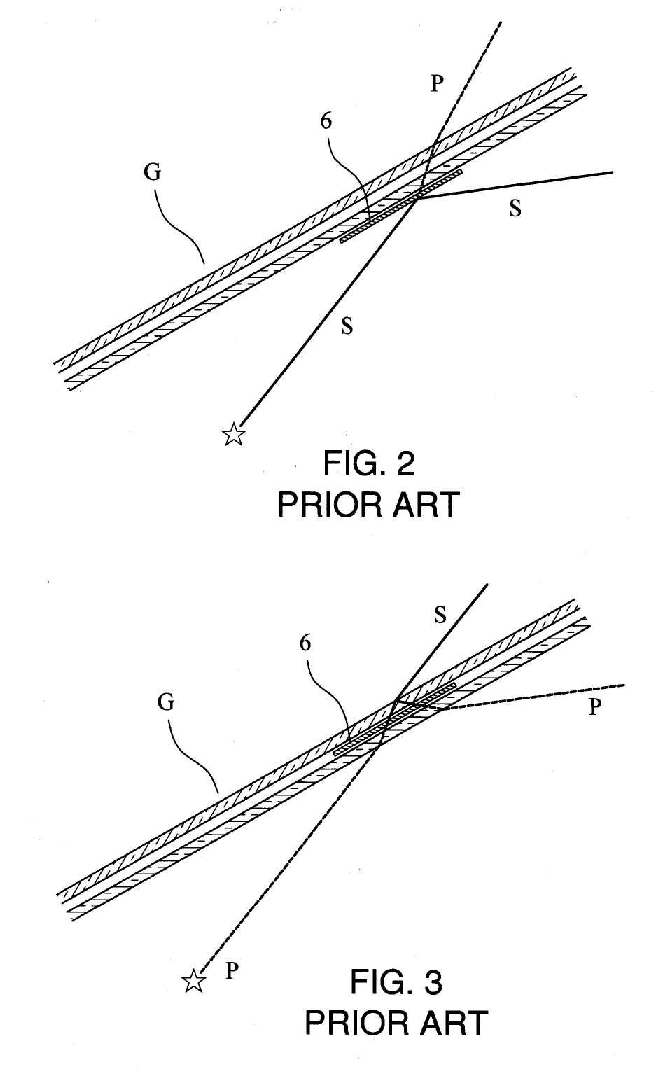

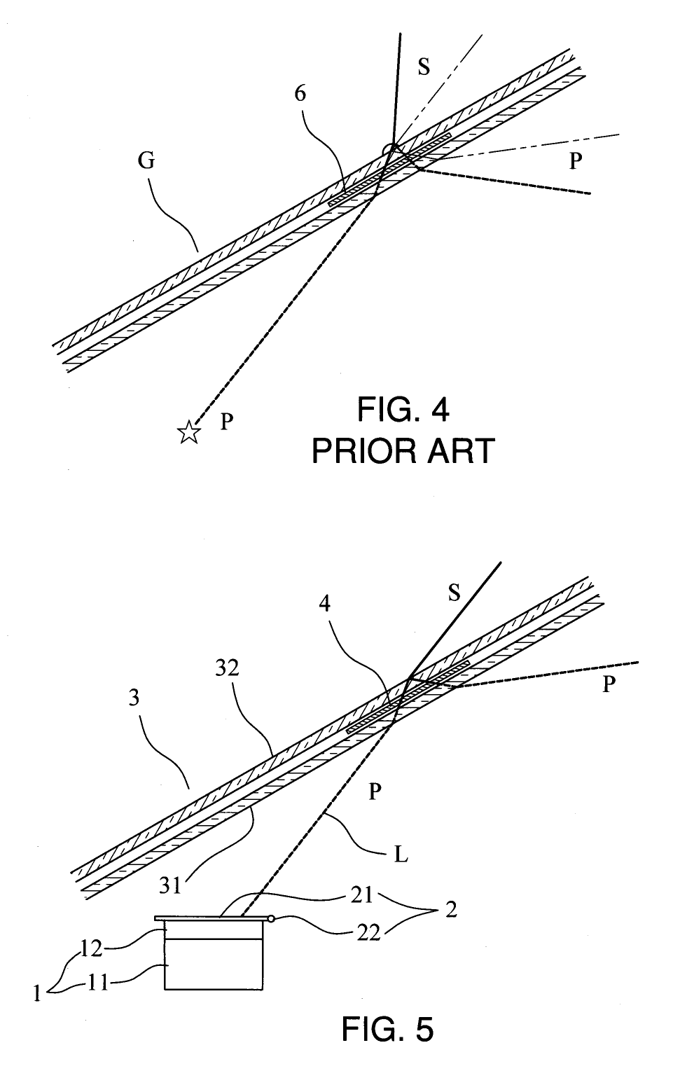

### DETAILED DESCRIPTION OF THE INVENTION

Please refer to FIG. 5, which is the adjustable head-up display system of all time of the present invention, including:

a display device 1, which includes a projection device 11 and an imaging screen 12;

a rotating device 2, which includes a first half-wave plate 21 and a power module 22, the first half-wave plate 21 is set in front of the display device 1, the first half-wave plate 21 is connected to the power module 2, the first half-wave is plate 21 is transparent plastic material;

a windshield 3, which includes a first glass 31 and a second glass 32, light L projected by the display device 1 reflects in the windshield 3;

a second half-wave plate 4, which is set between the first glass 31 and the second glass 32, the bottom of the second half-wave plate 4 is attached to the display location of the first glass 31, the second glass 32 is covered on, and then deaeration and gluing procedures are performed, the second half-wave plate 4 is transparent plastic material.

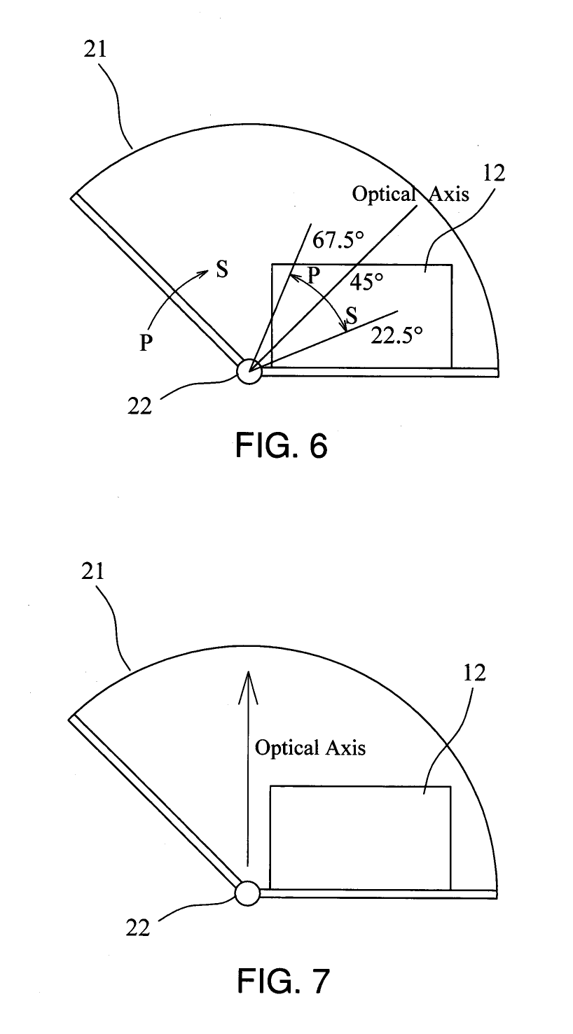

As shown in FIG. 6, which is a schematic diagram of the first embodiment of the present invention, wherein the imaging screen 12 is a 45 degree linear polarization imaging screen, the first half-wave plate 21 is a sector, the power module 22 is an electric motor; when the optical axis of the first half-wave plate 21 rotates downwards to 22.5 degrees, the 45 degree polarized light of the imaging screen 12 clockwise rotates 45 degrees (which is 22.5 degrees'2) to reach the horizontal direction and becomes a s-polarized light (s shown in figure); when the first half-wave plate 21 rotates upwards to 67.5 degrees, the 45 degree polarized light of the imaging screen 12 counterclockwise rotates 45 degrees to reach the vertical direction and becomes a p-polarized light (p shown in figure).

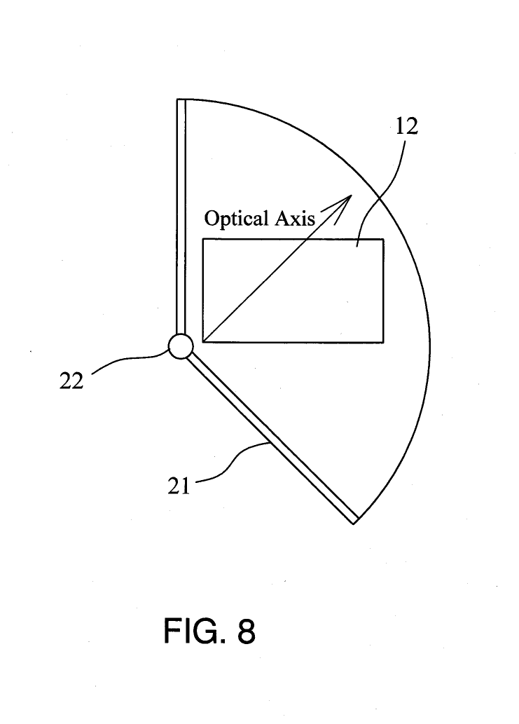

As shown in FIG. 7, which is a schematic diagram of the second embodiment of the present invention, wherein the imaging screen 12 is an imaging screen using p-polarized light, the first half-wave plate 21 is a sector plate body, the power module 22 is an electric motor; direction of optical axis of the first half-wave plate 21 and polarized light direction of the imaging screen 12 is the same, the inclined angle is zero, thus the polarized direction would not be changed. As shown in FIG. 8, after the first half-wave plate 21 is rotated, the 1optical axis of the first half-wave plate 21 is 45 degrees to the direction of polarized light of the imaging screen 12, and the polarized direction is rotated 90 degrees to become s-polarized light; by the same principle, the display device 1 includes the projection device 11 and the imaging screen 12, wherein is the imaging screen 12 is an imaging screen using s-polarized light, the imaging screen 12 could also be used correspondingly to change s-polarized light and p-polarized light.

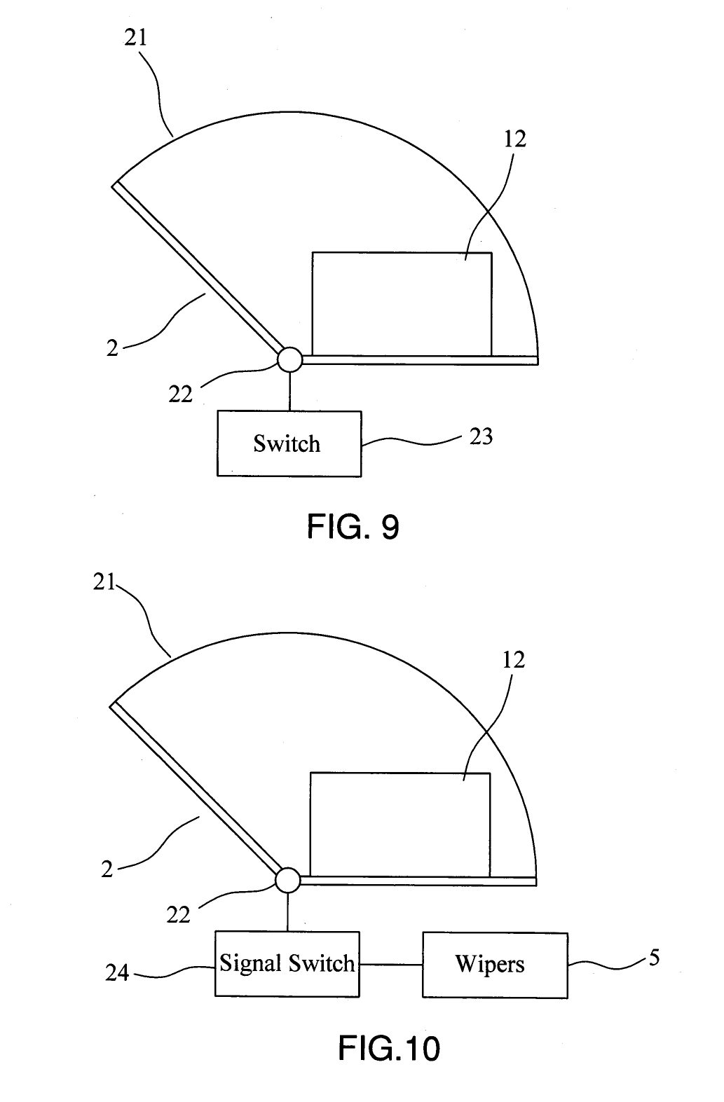

The control mode of the above first half-wave plate 21 for changing polarized light could be manual mode, wherein the rotating device 2 further includes a switch 23 (as shown in FIG. 9) for controlling the power module 22 to rotate the first half-wave plate 21; it is set to s-polarized light when a vehicle starts, if a driver could not see the images displayed by the adjustable head-up display system of all time with wearing a polarized sunglasses, he could press the switch 23 to rotate the first half-wave plate 21, it would be switched to output as p-polarized light to solve the problem that images could not be seen if the driver wears a polarized sunglasses.

The control mode of the above first half-wave plate 21 for changing polarized light could be automatic mode, wherein the rotating device 2 further includes a signal switch 24 (as shown in FIG. 10); if the signal switch 24 receives wiper signals, it would control the power module 22 to rotate the first half-wave plate 21 according to motion of wipers 5; if the wipers 5 do not move, it means there is no raindrop, and p-polarized light is used; if the wipers 5 move, it means there are raindrops, and s-polarized light is used; so that the driver could control the output images as s-polarized light or p-polarized light; when the vehicle starts, it could be switched to s-polarized light to avoid from affecting by rain raindrops; when the driver wears a polarized sunglasses, it could be switched to p-polarized light to avoid displayed images from being filtered by the polarized sunglasses.

The feature of the adjustable head-up display system of all time of the present invention is mainly includes a display device, a rotating device, a windshield and a second half-wave plate, wherein the rotating device includes a first half-wave plate and a power module; the power module is provided to be controlled to rotate the first half-wave plate by manual mode or automatic mode, to let s-polarized light and p-polarized light interchange with each other and choose the outputs as s-polarized light or p-polarized light, to thereby solve the problem that images displayed by head-up displays couldn't be read if drivers wear polarized sunglasses and the image distorted problem in rainy days; thus, the present invention could provide drivers with displayed images with optimized visual effects for all time according to weather conditions, to thereby improve driving safety.

What is claimed is:

1. An adjustable head-up display system of all time, including:
a display device;
a rotating device, which includes a first half-wave plate and a power module, the first half-wave plate is set in front of the display device, the first half-wave plate is connected to the power module;
a windshield, which includes a first glass and a second glass, light projected by the display device reflects on the windshield;
a second half-wave plate, which is set between the first glass and the second glass.

2. The adjustable head-up display system of all time as claimed in claim 1, wherein the first half-wave plate and the second half-eave plate are transparent plastic material.

3. The adjustable head-up display system of all time as claimed in claim 1, wherein the rotating device further includes a switch, the switch is provided to control the power module for rotating the first half-wave plate.

4. The adjustable head-up display system of all time as claimed in claim 1, wherein the rotating device further includes a signal switch, the signal switch is provided to control the power module for rotating the first half-wave plate.

5. The adjustable head-up display system of all time as claimed in claim 1, wherein the display device includes a projection device and an imaging screen, the imaging screen is a 45 degree linear polarization imaging screen.

6. The adjustable head-up display system of all time as claimed in claim 1, wherein the display device includes a projection device and an imaging screen, the imaging screen is an imaging screen using p-polarized light.

7. The adjustable head-up display system of all time as claimed in claim 1, wherein the display device includes a projection device and an imaging screen, the imaging screen is an imaging screen using s-polarized light.

8. The adjustable head-up display system of all time as claimed in claim 1, wherein the power module is an electric motor.

9. The adjustable head-up display system of all time as claimed in claim 1, wherein the first half-wave plate is a sector plate body.

10. The adjustable head-up display system of all time as claimed in claim 1, wherein the display device includes a projection device and an imaging screen.
